(19) United States
(12) Patent Application Publication
(10) Pub. No.: US 2026/0104861 A1
(43) Pub. Date: Apr. 16, 2026

(54) INTELLIGENT CODE AUTOMATION

(71) Applicant: Truist Bank, Charlotte, NC (US)

(72) Inventor: Matthew Laine Donlan, Charlotte, NC (US)

(73) Assignee: Truist Bank, Charlotte, NC (US)

(21) Appl. No.: 18/911,812

(22) Filed: Oct. 10, 2024

(51) Int. Cl. G06F 8/35

(52) U.S. Cl. CPC G06F 8/35

(57) ABSTRACT

An application executing on a processor may receive a natural language request to generate source code. A large language model (LLM) executing on the processor may analyze the natural language request to determine a requested function. The LLM may determine, based on a source code base, one or more requirements for generating the source code. The LLM may generate, based on the one or more requirements, the source code. The application may store the source code in the source code base.

### BACKGROUND

Natural language processing (NLP) is a field of computer science and artificial intelligence (AI) that focuses on enabling computers to understand, interpret, and generate human language. NLP techniques are used in various applications such as speech recognition, text-to-speech systems, machine translation, and information retrieval.

Generating source code from natural language requests presents significant challenges for the field of AI. One problem is understanding the context and intent behind a request to produce accurate and meaningful code. Further still, conventional solutions have not successfully translated high-level natural language descriptions into source code that integrates with disparate systems in a computing environment. Therefore, generating source code from natural language remains an area of active research with many open problems.

### BRIEF SUMMARY

Embodiments of the present disclosure address the above needs and/or achieve other advantages by providing apparatuses, media, and methods that provide intelligent code automation.

In various embodiments, a method can be described for generating source code based on natural language requests. This process involves an application receiving the request and passing it to a large language model (LLM) executing on a processor. The LLM then analyzes the request to determine the requested function and identifies requirements based on a pre-existing source code base. Subsequently, the LLM generates the corresponding source code according to these requirements.

Similarly, an apparatus for generating source code can be described as comprising a processor and memory that store instructions. When executed by the processor, these instructions enable receiving a natural language request via an application, analyzing the request with an LLM to determine the requested function, identifying requirements based on a source code base, and generating the corresponding source code according to the identified requirements. The application may and store the generated code in the source code base.

In various embodiments, a non-transitory computer-readable storage medium may include instructions that enable the execution of certain processes by a processor. When executed, these instructions allow the processor to receive a natural language request from an application and analyze it using a large language model (LLM). The LLM then uses its analysis to determine the requested function and identify requirements for generating source code based on a pre-existing source code base. Subsequently, the LLM generates the required source code. The application may and store the generated code in the source code base.

The features, functions, and advantages that have been discussed may be achieved independently in various embodiments of the present disclosure or may be combined in yet other embodiments, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates an aspect of the subject matter in accordance with one embodiment.

FIG. 2 illustrates an aspect of the subject matter in accordance with one embodiment.

FIG. 3A illustrates an aspect of the subject matter in accordance with one embodiment.

FIG. 3B illustrates an aspect of the subject matter in accordance with one embodiment.

FIG. 3C illustrates an aspect of the subject matter in accordance with one embodiment.

FIG. 4 illustrates a routine 400 in accordance with one embodiment.

FIG. 5A is a diagram of a feedforward network, according to at least one embodiment, utilized in machine learning.

FIG. 5B is a diagram of a convolutional neural network, according to at least one embodiment, utilized in machine learning.

FIG. 5C is a diagram of a portion of the convolutional neural network of FIG. 5B, according to at least one embodiment, illustrating assigned weights at connections or neurons.

FIG. 6 is a diagram representing an exemplary weighted sum computation in a node in an artificial neural network.

FIG. 7 is a diagram of a Recurrent Neural Network (RNN), according to at least one embodiment, utilized in machine learning.

FIG. 8 is a schematic logic diagram of an artificial intelligence program including a front-end and a back-end algorithm.

FIG. 9 is a flow chart representing a method, according to at least one embodiment, of model development and deployment by machine learning.

FIG. 10 illustrates a computing system 1000 in accordance with one embodiment.

### DETAILED DESCRIPTION

Embodiments disclosed herein provide techniques for intelligent code automation. Generally, embodiments disclosed herein may generate code that can be successfully integrated into a computing environment. For example, an enterprise computing environment may have numerous diverse types of hardware and/or software elements. As the computing environment evolves, new software and/or features may be added. However, generating code that includes the desired functionality is not sufficient to integrate the code into the computing environment. The computing environment may include various requirements, such as required integrations, workflows, processes, rules, laws, parameters, and the like.

Advantageously, embodiments disclosed herein provide techniques to train a model to generate code based on natural language requests, where the code is fully integrable into a given computing environment. The model may be trained on the source code and other data describing a computing environment. The training of the model based on the source code and other data allows the model to learn the various requirements for integration into the computing environment. For example, the training may allow the model to learn how to interact with fraud platforms, cloud deployment services, databases, applications, etc., in the computing environment. Once trained, a user may provide a natural language request to generate source code. The model may be used to generate source code based on the natural language request, where the source code is fully compliant with all requirements for the target computing environment.

For example, a user may provide a natural language request to generate source code for a feature to transfer funds between accounts in a user application. Embodiments disclosed herein may process the request to generate source code that is compliant with the user application and all systems the user application must interact with. For example, embodiments disclosed herein may generate code that knows the storage location of account information in a database such that the code is able to move funds from one account into another account and the balances are updated in the database. Further still, embodiments disclosed herein may generate the code to fully comply with relevant fraud, security, and/or regulatory requirements. For example, embodiments disclosed herein may generate code that satisfies regulatory requirements such as minimum holding time periods, maximum transfer amount limits, maximum number of transfers per account per period of time, etc. Further still, by generating code that can integrate with a cloud services platform, embodiments disclosed herein automate the generation and deployment of code onto the cloud services platform such that the code is available in production systems. Embodiments are not limited in these contexts.

Advantageously, embodiments disclosed herein may train models to generate source code that is fully integrable into computing environments. Conventional solutions lack the ability to understand all requirements in a given computing environment. By training models that can generate fully integrable source code based on natural language requests, embodiments disclosed herein overcome the shortcomings of conventional solutions. For example, generating fully compliant source code based on natural language requests improves the functioning of artificial intelligence systems that generate source code. For example, by generating code that can communicate with all other system components in a computing environment, the artificial intelligence systems reduce the amount of processing resources and time to generate code. Furthermore, by reducing the amount of manual source code generation and/or modification, embodiments provide an advantage in terms of amount of time and resources used to deploy fully functioning software. By providing fully automated code generation and deployment functionality, embodiments disclosed herein improve the functioning of systems used to generate source code such that a single request can be used to generate code and deploy the code to live production systems in a cloud platform. Embodiments are not limited in these contexts.

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the disclosure and enable one of ordinary skill in the art to make, use, and practice the disclosure.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

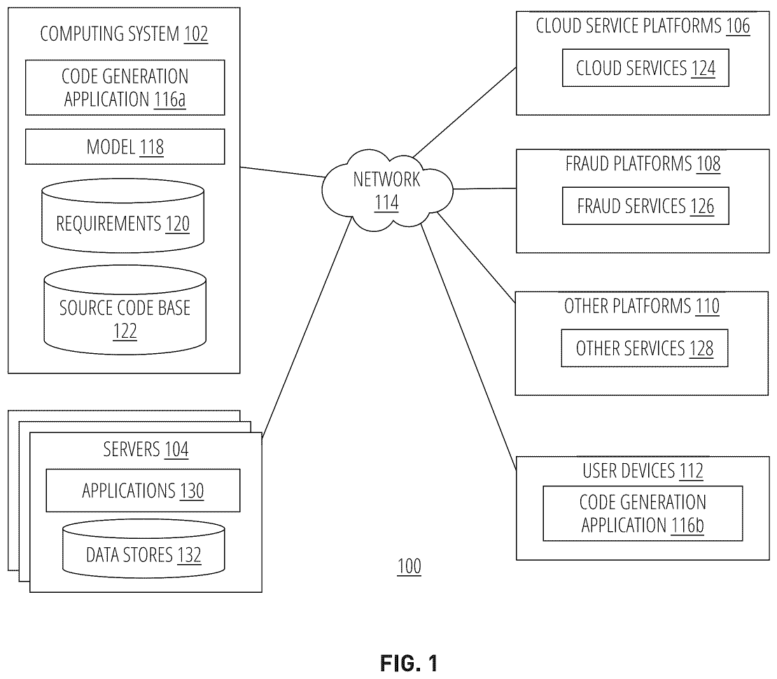

FIG. 1 illustrates a system 100 that provides intelligent code automation, according to one embodiment. As shown, the system 100 includes one or more computing systems 102, one or more servers 104, one or more cloud service platforms 106, one or more fraud platforms 108, one or more other platforms 110, and one or more user devices 112 via one or more networks 114. The computing systems 102, servers 104, cloud service platforms 106, fraud platforms 108, other platforms 110, and/or user devices 112 are representative of any type of physical and/or virtualized computing system.

As shown, the servers 104 may store or otherwise host a plurality of applications 130. The applications 130 are representative of any number and type of application. For example, the applications 130 may include web browsers, account management applications, mobile P2P payment system client applications, applications provided by financial institutions, financial applications, payment applications, network functions, Automated Clearing House (ACH) applications, FedNow payment applications, real-time payments (RTP) applications, monetary transfer applications, mobile wallet applications, accounting applications, payment processing frameworks, etc. Although depicted as applications, the application 130 may are representative of any type of executable code, such as services, microservices, application programming interfaces (APIs), etc. Regardless of the type of a given application 130, in some embodiment s, the applications 130 may include features to process at least a portion of a transaction. The transactions may include purchases, payments, equity transactions, cryptocurrency sales, or any type of transaction. Furthermore, a given transaction may be processed at least in part by multiple applications 130. Further still, a given operation (including processing transactions) may include processing performed by multiple components of the system 100.

The servers 104 may store or otherwise provide access to data stores 132. The data stores 132 are representative of any number and type of data storage solutions, which may include databases, files, spreadsheets, storage media, and the like. Examples of data stores 132 include, but are not limited to, account databases for customer accounts, databases for payment accounts, production databases for applications, financial institution databases, databases for cached data, and databases for files such as those for user accounts, user profiles, account balances, and transaction histories, files downloaded or received from other devices, and other data items and the like. Example accounts include a checking account, a savings account, a money market account, a certificate of deposit, a mortgage or other loan account, a retirement account, a brokerage account, or any other type of account.

The cloud service platforms 106 provide cloud services 124, which are representative of services to host, manage, and scale applications such as applications 130 without the need to manage physical servers. Examples of cloud service platforms 106 include, but are not limited to, Amazon® Web Services (AWS), Google® Cloud Platform (GCP), and Microsoft® Azure. For example, source code for an application 130 may be deployed to live production systems (e.g., one or more of the servers 104) via the cloud service platform 106 such that users can access the application 130. Embodiments are not limited in these contexts, as the cloud service platforms 106 may provide any number and type of cloud-related services.

The fraud platforms 108 provide fraud services 126, which may detect, prevent, and manage fraudulent activities. For example, an application 130 may allow users to pay for purchases via one or more accounts having account information in one or more of the data stores 132. However, various requirements in the system 100 may specify that a payment request processed by the application 130 needs to be processed by the fraud platform 108 to ensure the request is not fraudulent. Embodiments are not limited in these contexts, as the fraud platform 108 may provide any number and type of fraud-related services. The other platforms 110 are representative of other platforms, including software services, applications, etc.

As shown, the computing system 102 includes a code generation application 116a and the user devices 112 include a corresponding code generation application 116a. The code generation application 116a may be the same as code generation application 116b. For example, the code generation application 116b may be a client-side instance of the application, while the code generation application 116a may be a server-side instance of the application. Although not depicted for the sake of clarity, the user devices 112 may include one or more of the applications 130 and/or data stores 132.

The computing system 102 further includes one or more models 118, one or more data stores of requirements 120, and one or more source code bases 122. The source code bases 122 may store the source code for some or all of the software in the system 100 (e.g., the applications 130, etc.). The requirements 120 may include various requirements for entities the system 100. Generally, a given hardware entity or software entity may be associated with one or more entries in the requirements 120, where each entry specifies one or more requirements for the associated entity.

Examples of requirements that are stored in the requirements 120 include, but are not limited to, required programming languages, policies, security requirements, access permissions, regulatory requirements (e.g., requirements to comply with laws), rules, thresholds, actions, workflows, integrations (e.g., with other applications 130, the fraud platforms 108, cloud service platforms 106, other platforms 110, etc.), processes, storage locations, and the like. In some embodiments, even though there may be dozens of possible ways to implement functionality, the requirements 120 may permit the functionality to be implemented in a subset of the possible ways (e.g., permitting secure methods, restricting unsecure methods, restricting unencrypted methods, etc.). More generally, any number and types of requirements may be associated with hardware and/or software in the requirements 120.

For example, the requirements 120 may specify, for a digital wallet applications, the programming language for the digital wallet applications, required integrations with the fraud platforms 108, cloud service platforms 106, and/or other platforms 110, rules specified by laws and/or regulations, performance requirements (e.g., Quality of Service (QOS) requirements), service level agreement (SLA) requirements, workflows (e.g., the series of operations and corresponding actors in the system 100 to perform a processing operation, such as processing a payment), locations of digital wallets in the data stores 132, etc. Embodiments are not limited in these contexts, as the requirements 120 may specify any number and type of requirements. Furthermore, the requirements 120 may include predetermined requirements and/or requirements provided by users.

The model 118 is an artificial intelligence (AI) model that generates source code for the system 100 based at least in part on the requirements 120 and source code bases 122. The model 118 may be any type of AI model, such as a large language model (LLM), neural network, machine learning model, etc. The model 118 may be trained using training data. Examples of training data that may be used to train the model 118 include the source code bases 122 and/or the requirements 120. In some embodiments, the model 118 is trained based on the source code bases 122, e.g., source code examples that are compliant with different programming languages, frameworks, and requirements of the system 100. For example, the model 118 may be trained to learn features of the source code in the source code bases. Such features may include requirements such as the requirements 120. By learning such features, or requirements, the model 118 may be trained to generate source code that is fully integrable with the system 100. Embodiments are not limited in these contexts.

Training the model 118 may include annotating the training data, e.g., adding metadata describing requirements of the system 100 (e.g., associated functions, coding standards, architectural patterns, compliance regulations, the requirements 120) associated with the training samples of source code from the source code bases 122. Training the model 118 may further include preprocessing the training data. For example, the training data may be structured and cleaned to ensure consistency (e.g., removing noise, handling missing values, removing non-compliant code, etc.). The training data may further be tokenized.

The preprocessed and annotated training dataset is then used to train the model 118. During this process, the model 118 is provided with input features derived from the training data and any requirements. The training may include emphasizing compliance by reinforcing correct coding practices and penalizing non-compliant examples. As the model 118 generates code, training the model 118 may include feedback mechanisms such as reinforcement learning (e.g., feedback loops where the model 118 is rewarded for generating compliant code), automated testing (e.g., using code analysis tools to evaluate the generated code against predefined compliance criteria). The training may further include evaluation and validation (e.g., to assess the usability of the code, whether the code executes, whether the code is compliant with the various requirements 120, etc.).

The trained model 118 may then be used to generate source code that is compliant with the system 100. For example, a user of the code generation application 116b may provide a natural language request to generate source code. However, the natural language request may not specify one or more of the requirements 120. For example, the natural language request may specify “generate a page to view an account balance.” Such a request conveys intent but does not specify various requirements 120, such as integration with the fraud platform 108, etc. The code generation application 116b may transmit an indication of the request to the code generation application 116a. The code generation application 116a may provide the indication of the request to the model 118. The model 118 may then tokenize the input (e.g., the natural language request) and use its embeddings to understand the meaning and intent behind the natural language request. For example, based on the embeddings, the model 118 may determine a function associated with the request (e.g., an account balance page). The model 118 recognizes programming concepts, parameters, requirements, and constraints based on the training. Doing so allows the model 118 to recognize intent (e.g., that the user wants a page to view account balances) and/or context.

The model 118 may then generate source code based on the request. For example, the model 118 may generate code based on the requirements and any constraints learned during training. Doing so may include the model 118 checking the generated code against compliance requirements, (e.g., ensuring adherence to coding standards (e.g., variable naming conventions), implementing security best practices (e.g., input validation), performing logic checks to ensure the code functions as intended, etc.). The model 118 may further generate comments and/or documentation.

In some embodiments, the model 118 may then output the generated code for display, e.g., to a user. In such embodiments, the user may optionally edit the code and/or approve the code for deployment. However, in some embodiments, the code may be automatically deployed via the cloud service platform 106 without requiring user input. For example, the code generation application 116a may initiate deployment of the code via the cloud service platform 106 using a continuous integration/continuous deployment (CI/CD) pipeline. Doing so allows the generated source code to be accessed via one or more devices, e.g., the user devices 112. Furthermore, the code generation application 116a may store the source code generated by the model 118 in one or more of the source code bases 122. In some embodiments, the code generation application 116a may compile the code or otherwise prepare the code for deployment via the cloud service platform 106 and/or storage in the source code base 122.

For example, the model 118 may generate the source code for the account balance page, such that the code is compliant with the fraud platform 108, cloud service platform 106, and other platforms 110. The model 118 may further generate the source code for the account balance page such that it complies with other requirements, e.g., security requirements (e.g., to obscure or otherwise hide sensitive information such as account numbers, social security numbers, etc.), required programming languages, required appearances (e.g., fonts, colors, etc., of an application in which the page will be included, etc.), and the like. Doing so allows the organization associated with the system 100 to automate code generation such that the model 118 generates compliant code. Doing so improves the functioning of the system 100, as any code generated by the model 118 is fully compliant with the requirements 120. For example, functions provided by the code generated by the model 118 may be verified using the fraud platform 108, deployed using the cloud service platform 106, etc. Furthermore, doing so reduces the amount of time and resources to custom build (or otherwise configure) software that is compliant with the requirements 120. Embodiments are not limited in these contexts.

In one embodiment, when a user decides to enroll in a mobile banking program, the user downloads or otherwise obtains the mobile banking system client application from a mobile banking system, for example enterprise system 100, or from a distinct application server. In other embodiments, the user interacts with a mobile banking system via a web browser application in addition to, or instead of, the mobile P2P payment system client application.

The network 114 may also incorporate various cloud-based deployment models including private cloud (e.g., an organization-based cloud managed by either the organization or third parties and hosted on-premises or off premises), public cloud (e.g., cloud-based infrastructure available to the general public that is owned by an organization that sells cloud services), community cloud (e.g., cloud-based infrastructure shared by several organizations and manages by the organizations or third parties and hosted on-premises or off premises), and/or hybrid cloud (e.g., composed of two or more clouds e.g., private community, and/or public).

The user devices 112 may include automatic teller machines (ATMs) utilized by the system 100 in serving users. In another example, the servers 104 represent payment clearinghouse or payment rail systems for processing payment transactions, and in another example, the servers 104 such as merchant systems or banking systems configured to interact with the user devices 112 during transactions and also configured to interact with the enterprise system 100 in back-end transactions clearing processes.

System 100 as illustrated diagrammatically represents at least one example of a possible implementation, where alternatives, additions, and modifications are possible for performing some or all of the described methods, operations, and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The system 100 can offer any number or type of services and products to one or more users. In some examples, an enterprise system 100 offers products. In some examples, an enterprise system 100 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 100, automated assistance may be provided by the enterprise system 100. For example, automated access to user accounts and replies to inquiries may be provided by enterprise-side automated voice, text, and graphical display communications and interactions. In at least some examples, any number of human agents, can be employed, utilized, authorized, or referred by the enterprise system 100. Such human agents can be, as non-limiting examples, point of sale or point of service (POS) representatives, online customer service assistants available to users, advisors, managers, sales team members, and referral agents ready to route user requests and communications to preferred or particular other agents, human or virtual.

Human agents may utilize agent devices (e.g., user devices 112) to serve users in their interactions to communicate and take action. In such embodiments, the user devices 112 can be, as non-limiting examples, computing devices, kiosks, terminals, smart devices such as phones, and devices and tools at customer service counters and windows at POS locations.

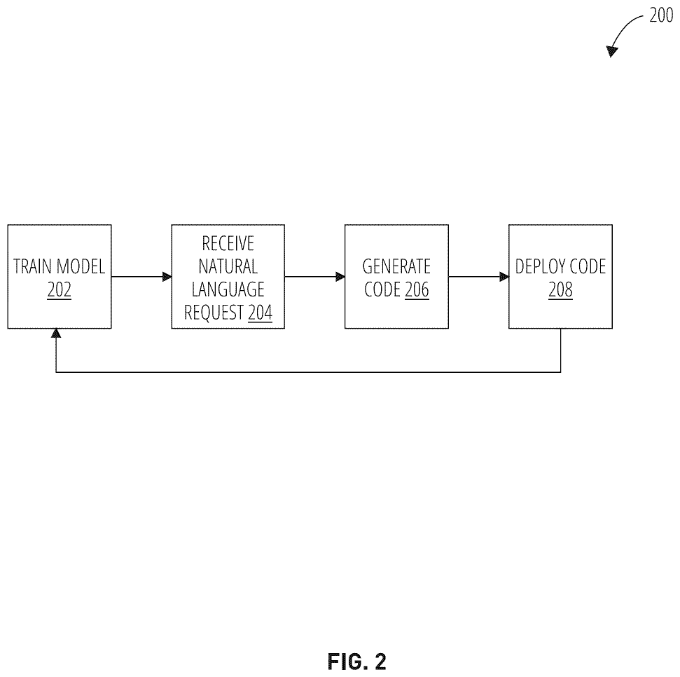

FIG. 2 illustrates an example logic flow 200 for intelligent code automation. Although the example logic flow 200 depicts a particular sequence of operations, the sequence may be altered without departing from the scope of the present disclosure. For example, some of the operations depicted may be performed in parallel or in a different sequence that does not materially affect the function of the logic flow 200. In other examples, different components of an example device or system that implements the logic flow 200 may perform functions at substantially the same time or in a specific sequence.

According to some examples, the logic flow 200 includes training a model at block 202. For example, the model 118 illustrated in FIG. 1 may be trained. The training may be based at least in part on the source code associated with an entity, e.g., the source code in source code bases 122. In some embodiments, the model 118 is trained based on the source code bases 122 and the requirements 120. Generally, the training allows the model 118 to generate code that can fully integrate into the system 100. For example, the model 118 can be trained to learn required programming languages, syntax, permissions (e.g., which account credentials should be provided by source code attempting to access a resource), permitted methods of programming (e.g., using linked lists instead of arrays, etc.), integration with services such as cloud service platform 106, fraud platform 108, and/or other platforms 110, queue locations, how to handle rule violations, where information is located, etc.

According to some examples, the logic flow 200 includes receiving a natural language request at block 204. For example, the code generation application 116a illustrated in FIG. 1 may receive natural language request from a user. The natural language request may specify to generate source code for a desired function. For example, the user may request a card lock feature for a banking application.

According to some examples, the logic flow 200 includes generating code at block 206. For example, the model 118 illustrated in FIG. 1 may generate code to implement the requested card lock feature. The code generation may include the model 118 identifying the requested function (e.g., the card lock) based on the request. The model 118 may further identify any relevant requirements for generating the source code. The model 118 may then generate the code to be compliant with the requirements, e.g., based on testing the code, validating the code, etc. Advantageously, based on the training, the model 118 is able to generate code that is fully operable in the system 100. For example, the model 118 may generate code that understands which way to lock a card (e.g., to enable a lock flag instead of deleting the card from the user's account in the data store 132).

According to some examples, the logic flow 200 includes deploying code at block 208. For example, the code generation application 116a illustrated in FIG. 1 may deploy code, e.g., via the cloud service platform 106. Doing so may allow the card lock feature to be enabled in the banking application such that users may utilize the card lock feature to lock their credit and/or debit card such that the card cannot be used until the card is unlocked.

In some embodiments, the logic flow 200 includes returning to block 202, e.g., to retrain the model 118 based on the source code generated by the model 118. Doing so trains the model 118 to generate code more accurately and with fewer errors. In some embodiments, the model 118 is re-trained at periodic time intervals. In some embodiments, rather than retraining the model 118, the logic flow 200 returns to block 204. Embodiments are not limited in these contexts.

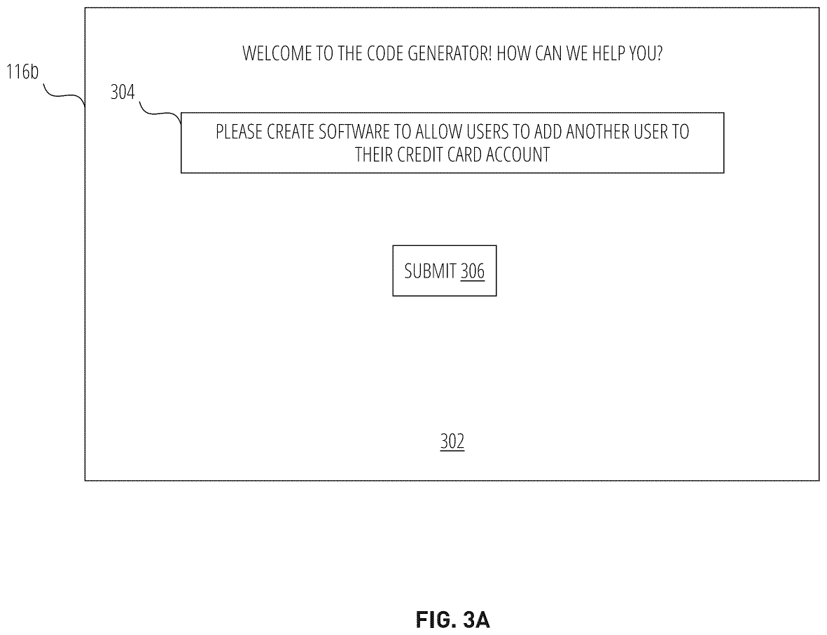

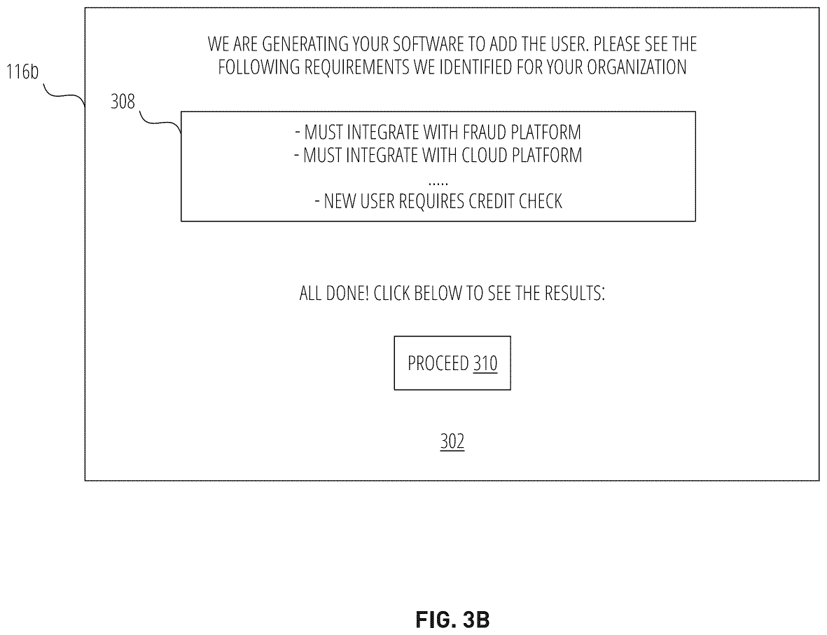

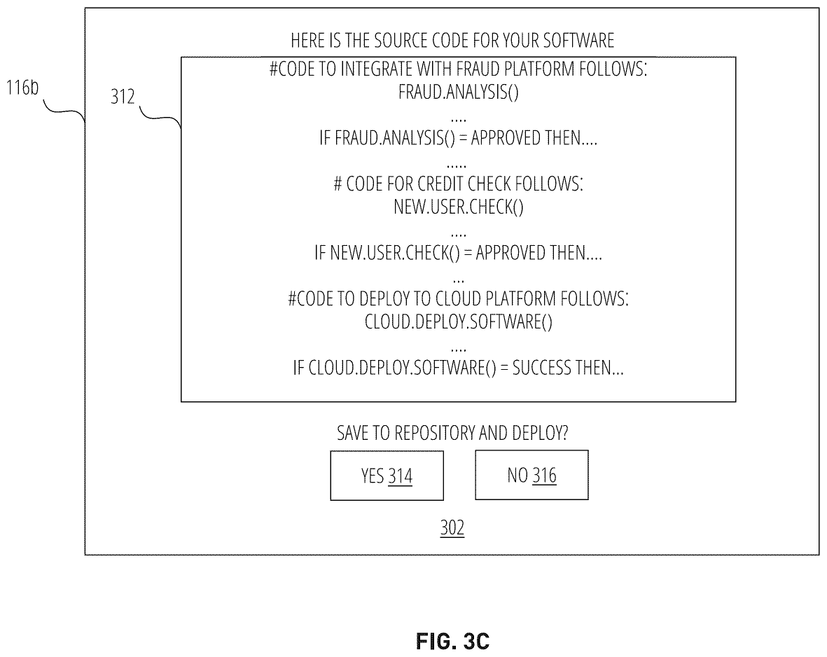

FIG. 3A illustrates an example graphical user interface 302 of the code generation application 116b, according to one embodiment. Although discussed with reference to the code generation application 116b, the code generation application 116a may provide the same or similar functionality discussed with reference to FIG. 3A-FIG. 3C. Embodiments are not limited in these contexts.

As shown, the graphical user interface 302 includes an input field 304 to receive natural language input from a user. In the example depicted in FIG. 3A, the user requests the generation of “software to allow users to add another user to their credit card account.” The user may submit the request via the selectable element 306. As stated, indications of the text in the input field 304 may be provided to the model 118, such that the model 118 may identify one or more associated functions (e.g., adding another user to an account). Doing so allows the model 118 to then identify any associated requirements 120 and generate the source code based on the identified requirements 120.

FIG. 3B illustrates an embodiment where the user submitted the request depicted in FIG. 3A using the selectable element 306. As shown, the graphical user interface 302 is updated to include a requirements section 308 that includes one or more requirements for the requested software identified by the model 118. As shown, the model 118 has identified the example requirements of integration with the fraud platform 108, integration with the cloud service platform 106, and that a credit check. Advantageously, the model 118 may generate source code that is compliant with these and other requirements. For example, the source code generated by the model 118 may include one or more valid function calls to the fraud platform 108 and one or more valid function calls to the cloud service platform 106. As another example, the source code generated by the model 118 may include code to process a credit check as part of the new user addition. The user may view the source code by accessing selectable element 310.

FIG. 3C illustrates a portion of source code 312 generated by the model 118 based on the natural language request. As shown, the source code 312 includes comments, code segments, etc., generated by the model 118. Advantageously, the source code 312 includes segments to carry out the requirements associated with adding a new user to a credit card account. For example, the source code 312 includes function calls for fraud analysis performed by the fraud platform 108, function calls associated with the credit check, and function calls to deploy the generated source code 312 to the cloud service platforms 106. As shown, the graphical user interface 302 includes selectable element 314 to save the source code 312 to the source code base 122 and deploy the source code 312 to a cloud service platform 106. Alternatively, the user may use selectable element 316 to reject saving and/or deployment of the source code 312. In some embodiments, the user may modify the source code 312 prior to saving and/or deploying the source code. Embodiments are not limited in these contexts.

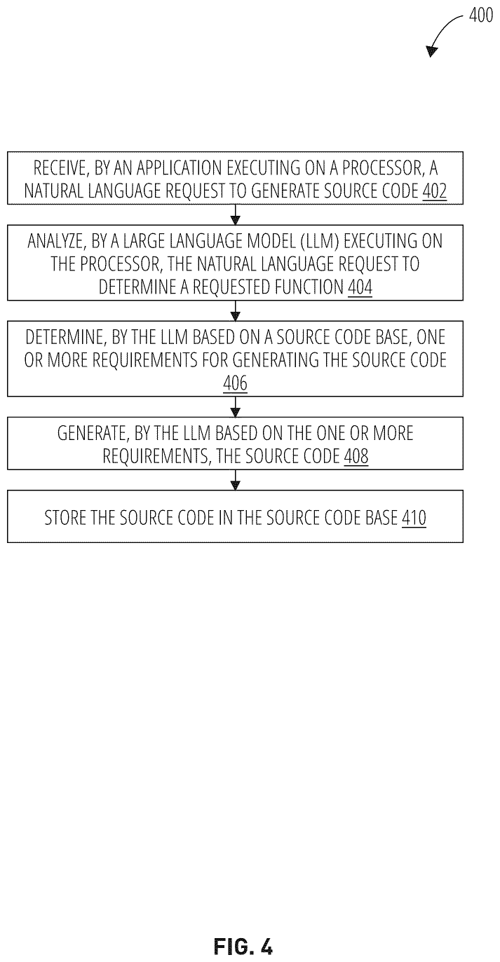

FIG. 4 illustrates an example routine 400 for intelligent code automation. Although the example routine 400 depicts a particular sequence of operations, the sequence may be altered without departing from the scope of the present disclosure. For example, some of the operations depicted may be performed in parallel or in a different sequence that does not materially affect the function of the routine 400. In other examples, different components of an example device or system that implements the routine 400 may perform functions at substantially the same time or in a specific sequence.

According to some examples, the routine 400 includes receiving, by an application executing on a processor, a natural language request to generate source code at block 402. For example, the code generation application 116a illustrated in FIG. 1 may receive a natural language request to generate source code. For example, the natural language request may specify to “generate code for new account registration.”

According to some examples, the routine 400 includes analyzing, by a large language model (LLM) executing on the processor, the natural language request to determine a requested function at block 404. For example, the model 118 illustrated in FIG. 1 may analyze the natural language request to determine a requested function. Continuing with the previous example, the model 118 may determine that the associated function is new account registration.

According to some examples, the routine 400 includes determining, by the LLM based on a source code base, one or more requirements for generating the source code at block 406. For example, the model 118 illustrated in FIG. 1 may determine, on a source code base 122, one or more requirements for generating the source code. For example, the requirements may include successful fraud analysis via the fraud platform 108, the appropriate location in the data stores 132 for storing the new account (e.g., database tables, etc.), and integration with the cloud service platform 106.

According to some examples, the routine 400 includes generating, by the LLM based on the one or more requirements, the source code at block 408. For example, the model 118 illustrated in FIG. 1 may generate, based on the one or more requirements, the source code. For example, the model 118 may generate source code for the new account registration page. Doing so may allow the user to create a new online account in adherence with the requirements 120.

According to some examples, the routine 400 includes storing the source code in the source code base at block 410. For example, the code generation application 116a illustrated in FIG. 1 may store the source code in the source code base 122. The source code may further be compiled, deployed, etc., such that a user of the user device 112 may create an account using the code. Embodiments are not limited in these contexts.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subject matter of these descriptions pertain.

A machine learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG, or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (DBSCAN), mean shift clustering, expectation maximization (EM) clustering using Gaussian mixture models (GMM), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph based models, neural models, and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient, e.g., a propagated value. The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

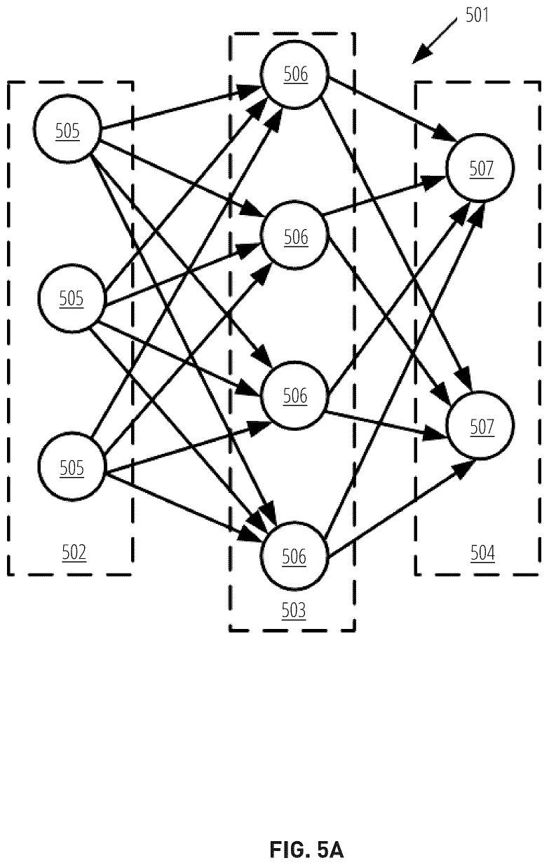

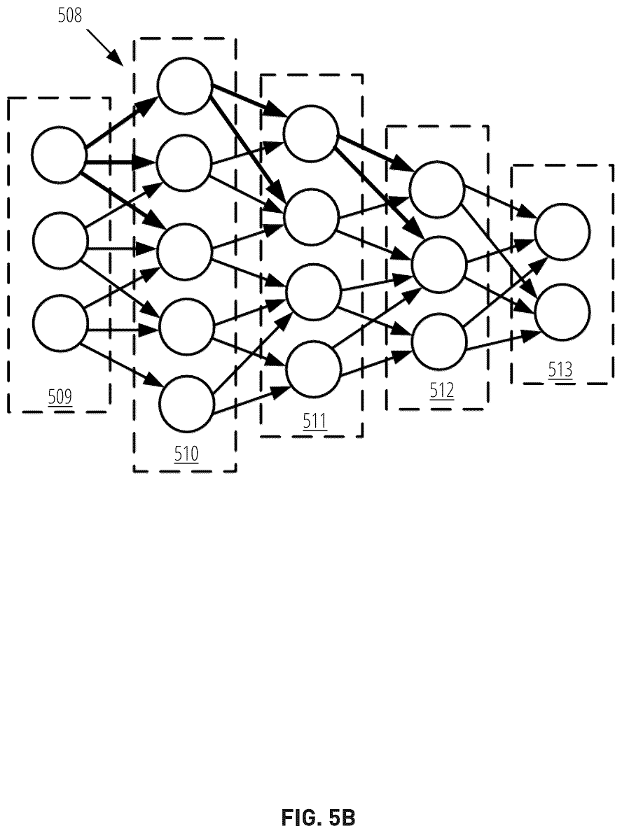

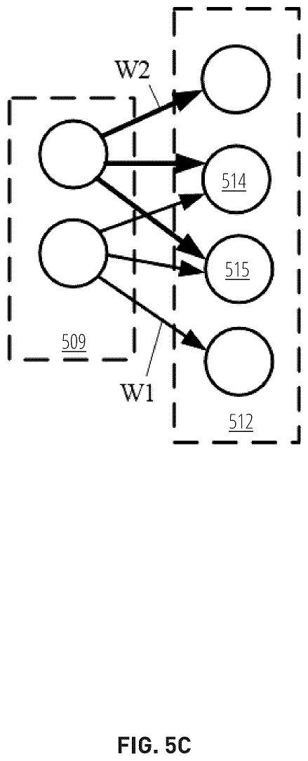

An artificial neural network (ANN), also known as a feedforward network, may be utilized, e.g., an acyclic graph with nodes arranged in layers. A feedforward network (see, e.g., feedforward network 501 referenced in FIG. 5A) may include a topography with a hidden layer 503 between an input layer 502 and an output layer 504. The input layer 502, having nodes commonly referenced in FIG. 5A as input nodes 505 for convenience, communicates input data, variables, matrices, or the like to the hidden layer 503, having nodes 506. The hidden layer 503 generates a representation and/or transformation of the input data into a form that is suitable for generating output data. Adjacent layers of the topography are connected at the edges of the nodes of the respective layers, but nodes within a layer typically are not separated by an edge. In at least one embodiment of such a feedforward network, data is communicated to the nodes 505 of the input layer, which then communicates the data to the hidden layer 503. The hidden layer 503 may be configured to determine the state of the nodes in the respective layers and assign weight coefficients or parameters of the nodes based on the edges separating each of the layers, e.g., an activation function implemented between the input data communicated from the input layer 502 and the output data communicated to the nodes 507 of the output layer 504. It should be appreciated that the form of the output from the neural network may generally depend on the type of model represented by the algorithm. Although the feedforward network 501 of FIG. 5A expressly includes a single hidden layer 503, other embodiments of feedforward networks within the scope of the descriptions can include any number of hidden layers. The hidden layers are intermediate the input and output layers and are generally where all or most of the computation is done. In some embodiments, the model 118 includes one or more feedforward networks 501.

An additional or alternative type of neural network suitable for use in the machine learning program and/or module is a Convolutional Neural Network (CNN). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program. A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An exemplary convolutional neural network CNN is depicted and referenced as 508 in FIG. 5B. As in the basic feedforward network 501 of FIG. 5A, the illustrated example of CNN 508 in FIG. 5B has an input layer 509 and an output layer 513. However where a single hidden layer 503 is represented in FIG. 5A, multiple consecutive hidden layers 510, 511, and 512 are represented in FIG. 5B. The edge neurons represented by white-filled arrows highlight that hidden layer nodes can be connected locally, such that not all nodes of succeeding layers are connected by neurons. In some embodiments, the model 118 includes one or more of the CNNs 508.

FIG. 5C, representing a portion of the convolutional neural network 508 of FIG. 5B, specifically portions of the input layer 509 and the first hidden layer 510, illustrates that connections can be weighted. In the illustrated example, labels W1 and W2 refer to respective assigned weights for the referenced connections. Two hidden nodes 514 and 515 share the same set of weights W1 and W2 when connecting to two local patches.

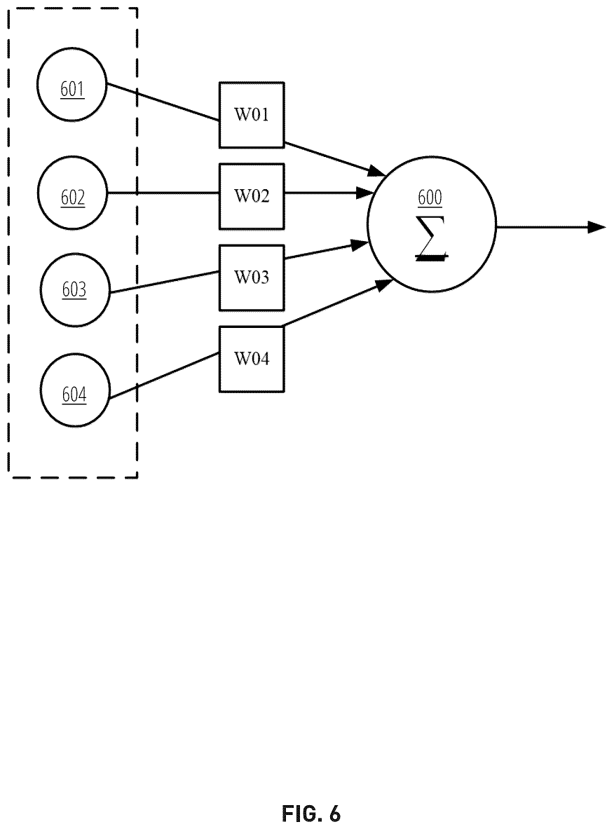

Weight defines the impact a node in any given layer has on computations by a connected node in the next layer. FIG. 6 represents a particular node 600 in a hidden layer. The node 600 is connected to several nodes in the previous layer representing inputs to the node 600. The input nodes 601, 602, 603 and 604 are each assigned a respective weight W01, W02, W03, and W04 in the computation at the node 600, which in this example is a weighted sum. In some embodiments, the model 118 includes one or more nodes 600.

An additional or alternative type of feedforward neural network suitable for use in the machine learning program and/or module is a Recurrent Neural Network (RNN). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current calculation of the parameter, e.g., at least a portion of the output data from the RNN may be used as feedback/input in calculating subsequent output data. In some embodiments, the machine learning module may include an RNN configured for language processing, e.g., an RNN configured to perform statistical language modeling to predict the next word in a string based on the previous words. The RNN(s) of the machine learning program may include a feedback system suitable to provide the connection(s) between subsequent and previous layers of the network.

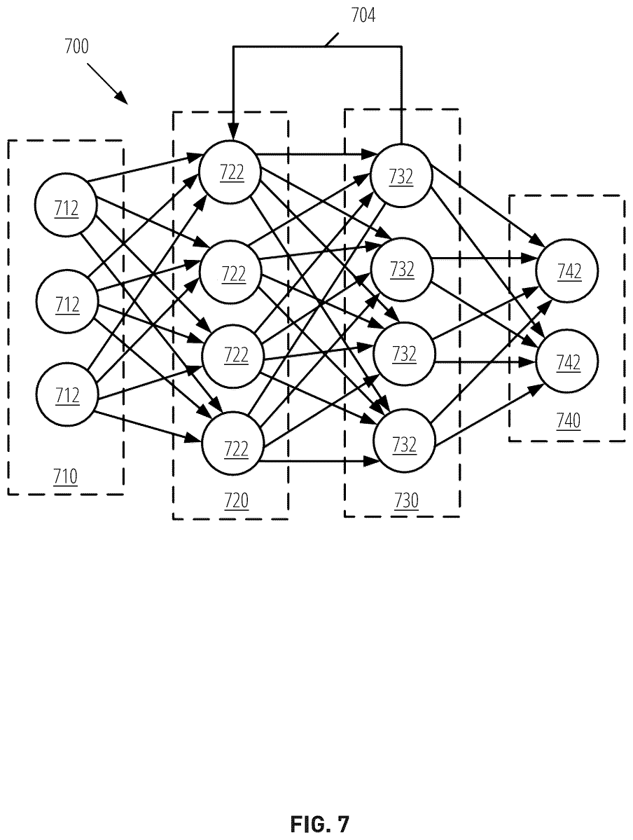

An example for a Recurrent Neural Network (RNN) is referenced as 700 in FIG. 7. As in the basic feedforward network 501 of FIG. 5A, the illustrated example of FIG. 7 has an input layer 710 (with nodes 712) and an output layer 740 (with nodes 742). However, where a single hidden layer 503 is represented in FIG. 5A, multiple consecutive hidden layers 720 and 730 are represented in FIG. 7 (with nodes 722 and nodes 732, respectively). As shown, the RNN 700 includes a feedback connector 704 configured to communicate parameter data from at least one node 732 from the second hidden layer 730 to at least one node 722 of the first hidden layer 720. It should be appreciated that two or more and up to all of the nodes of a subsequent layer may provide or communicate a parameter or other data to a previous layer of the RNN 700. Moreover and in some embodiments, the RNN 700 may include multiple feedback connectors 704 (e.g., connectors 704 suitable to communicatively couple pairs of nodes and/or feedback connectors 704 configured to provide communication between three or more nodes). Additionally or alternatively, the feedback connector 704 may communicatively couple two or more nodes having at least one hidden layer between them, i.e., nodes of nonsequential layers of the RNN 700. In some embodiments, the model 118 includes one or more of the RNNs 700.

In an additional or alternative embodiment, the machine-learning program may include one or more support vector machines. A support vector machine may be configured to determine a category to which input data belongs. For example, the machine-learning program may be configured to define a margin using a combination of two or more of the input variables and/or data points as support vectors to maximize the determined margin. Such a margin may generally correspond to a distance between the closest vectors that are classified differently. The machine-learning program may be configured to utilize a plurality of support vector machines to perform a single classification. For example, the machine-learning program may determine the category to which input data belongs using a first support vector determined from first and second data points/variables, and the machine-learning program may independently categorize the input data using a second support vector determined from third and fourth data points/variables. The support vector machine(s) may be trained similarly to the training of neural networks, e.g., by providing a known input vector (including values for the input variables) and a known output classification. The support vector machine is trained by selecting the support vectors and/or a portion of the input vectors that maximize the determined margin.

As depicted, and in some embodiments, the machine-learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers). Generally, the neural network(s) of the machine-learning program may include a relatively large number of layers, e.g., three or more layers, and may be referred to as deep neural networks. For example, the node of each hidden layer of a neural network may be associated with an activation function utilized by the machine-learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input/output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

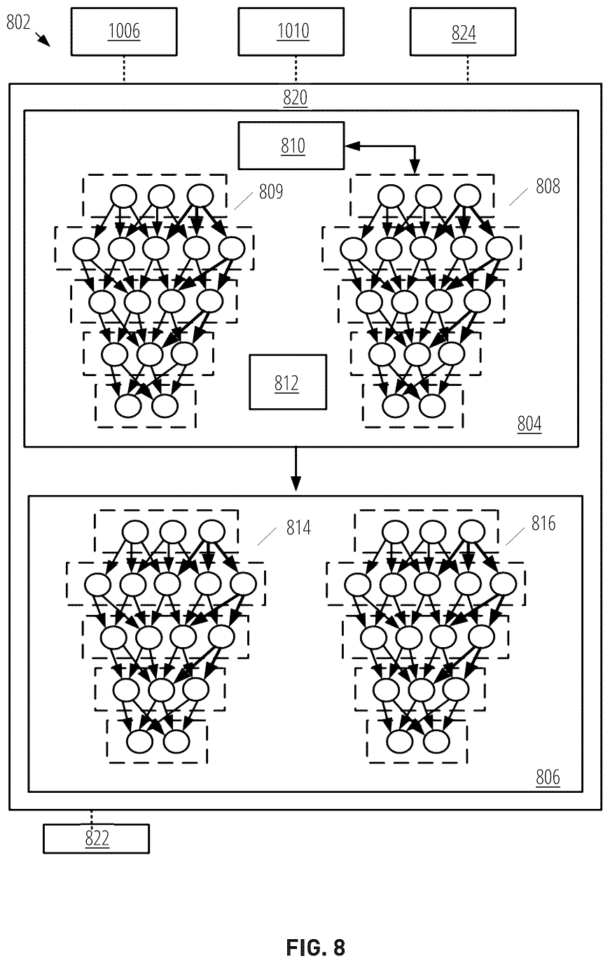

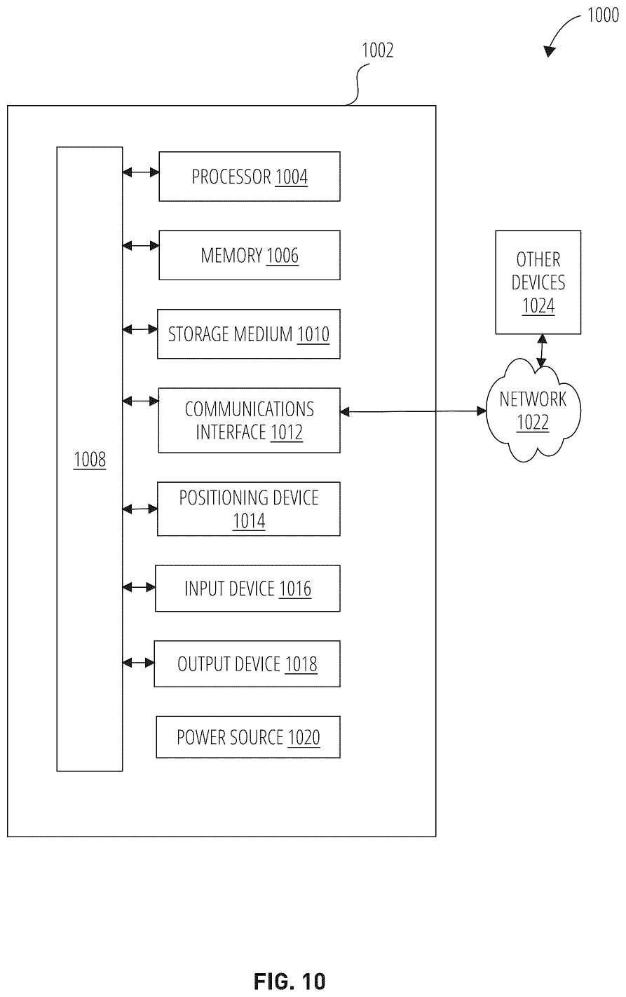

Referring now to FIG. 8 and some embodiments, an artificial intelligence (AI) program 802 may include a front-end network 804 and a back-end network 806. The artificial intelligence program 802 may be implemented on an AI processor 820, such as the processor 1004 of computer 1002 of FIG. 10, and/or a dedicated processing device. In some embodiments, the model 118 includes the artificial intelligence program 802 and components depicted in FIG. 8. The instructions associated with the front-end network 804 (also referred to as an “algorithm” or “program”) and the back-end network (also referred to as an “algorithm” or “program”) 806 may be stored in an associated memory device and/or storage device of the system (e.g., storage device 1024 and/or memory 1006 of FIG. 10, etc.) communicatively coupled to the AI processor 820, as shown. Additionally or alternatively, the system may include one or more memory devices and/or storage devices (represented by memory 824 in FIG. 8) for processing use and/or including one or more instructions necessary for operation of the AI program 802. In some embodiments, the AI program 802 may include a deep neural network (e.g., a front-end network 804 configured to perform pre-processing, such as feature recognition, and a back-end network 806 configured to perform an operation on the data set communicated directly or indirectly to the back-end network 806). For instance, the front-end network 804 can include at least one CNN 808 communicatively coupled to send output data to the back-end network 806.

Additionally or alternatively, the front-end program 804 can include one or more AI algorithms 810, 812 (e.g., statistical models or machine learning programs such as decision tree learning, associate rule learning, recurrent artificial neural networks, support vector machines, and the like). In various embodiments, the front-end program 804 may be configured to include built in training and inference logic or suitable software to train the neural network prior to use (e.g., machine learning logic including, but not limited to, image recognition, mapping and localization, autonomous navigation, speech synthesis, document imaging, or language translation such as natural language processing). For example, a CNN 808 and/or AI algorithm 810 may be used for image recognition, input categorization, and/or support vector training. In some embodiments and within the front-end program 804, an output from an AI algorithm 810 may be communicated to a CNN 808 or 809, which processes the data before communicating an output from the CNN 808, 809 and/or the front-end program 804 to the back-end program 806. In various embodiments, the back-end network 806 may be configured to implement input and/or model classification, speech recognition, translation, and the like. For instance, the back-end network 806 may include one or more CNNs (e.g., CNN 814) or dense networks (e.g., dense networks 816), as described herein.

For instance, and in some embodiments of the AI program 802, the program may be configured to perform unsupervised learning, in which the machine learning program performs the training process using unlabeled data, e.g., without known output data with which to compare. During such unsupervised learning, the neural network may be configured to generate groupings of the input data and/or determine how individual input data points are related to the complete input data set (e.g., via the front-end program 804). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 802 may be trained using a semi-supervised learning process in which some but not all of the output data is known, e.g., a mix of labeled and unlabeled data having the same distribution.

In some embodiments, the AI program 802 may be accelerated via a machine learning framework 822 (e.g., hardware). The machine learning framework may include an index of basic operations, subroutines, and the like (primitives) typically implemented by AI and/or machine learning algorithms. Thus, the AI program 802 may be configured to utilize the primitives of the framework 822 to perform some or all of the calculations required by the AI program 802. Primitives suitable for inclusion in the machine learning framework 822 include operations associated with training a convolutional neural network (e.g., pools), tensor convolutions, activation functions, basic algebraic subroutines and programs (e.g., matrix operations, vector operations), numerical method subroutines and programs, and the like.

It should be appreciated that the machine-learning program may include variations, adaptations, and alternatives suitable to perform the operations necessary for the system, and the present disclosure is equally applicable to such suitably configured machine learning and/or artificial intelligence programs, modules, etc. For instance, the machine-learning program may include one or more long short-term memory (LSTM) RNNs, convolutional deep belief networks, deep belief networks DBNs, and the like. DBNs, for instance, may be utilized to pre-train the weighted characteristics and/or parameters using an unsupervised learning process. Further, the machine-learning module may include one or more other machine learning tools (e.g., Logistic Regression (LR), Naive-Bayes, Random Forest (RF), matrix factorization, and support vector machines) in addition to, or as an alternative to, one or more neural networks, as described herein.

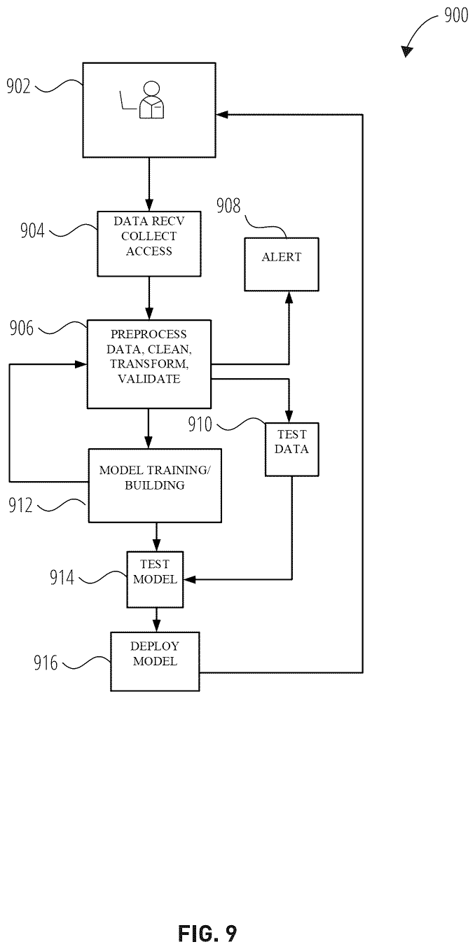

FIG. 9 is a flow chart representing a logic flow 900, according to at least one embodiment, of model development and deployment by machine learning. The logic flow 900 represents at least one example of a machine learning workflow in which operations are implemented in a machine-learning project. For example, the model 118 may be trained using logic flow 900.

In block 902, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, block 902 can represent a starting point. However, with regard to continuing or improving an ongoing machine learning workflow, block 902 can represent an opportunity for further user input or oversight via a feedback loop.

In block 904, data is received, collected, accessed, or otherwise acquired and entered as can be termed data ingestion. In block 906, the data ingested in block 904 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing block 906 is updated with newly ingested data, an updated model will be generated. Block 906 can include data validation, which focuses on confirming that the statistics of the ingested data are as expected, such as that data values are within expected numerical ranges, that data sets are within any expected or required categories, and that data comply with any needed distributions such as within those categories. Block 906 can proceed to block 908 to automatically alert the initiating user, other human or virtual agents, and/or other systems, if any anomalies are detected in the data, thereby pausing or terminating the process flow until corrective action is taken.

In block 910, training test data such as a target variable value is inserted into an iterative training and testing loop. In block 912, model training, a core step of the machine learning workflow, is implemented. A model architecture is trained in the iterative training and testing loop. For example, features in the training test data are used to train the model based on weights and iterative calculations in which the target variable may be incorrectly predicted in an early iteration as determined by comparison in block 914, where the model is tested. Subsequent iterations of the model training, in block 912, may be conducted with updated weights in the calculations.

When compliance and/or success in the model testing in block 914 is achieved, process flow proceeds to block 916, where model deployment is triggered. The model may be utilized in AI functions and programming, for example to simulate intelligent behavior, to perform machine assisted or computerized tasks, of which visual perception, speech recognition, decision-making, translation, forecasting, predictive modelling, and/or automated suggestion generation serve as non-limiting examples.

FIG. 10 illustrates an example computing system 1000 suitable for implementing various embodiments as described herein. As shown, the computing system 1000 comprises a computer 1002, which is representative of any type of physical and/or virtualized computing device. Examples of the computer 1002 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), container, or any other device with processing capabilities. In one embodiment, the computer 1002 is representative of some or all of the components of the computing system 102, servers 104, cloud service platforms 106, fraud platforms 108, other platforms 110, and/or user devices 112. More generally, the computing system 1000 is configured to implement all systems, methods, apparatuses, media, and embodiments disclosed herein.

As shown, the computer 1002 includes one or more processors 1004, one or more memories 1006, one or more non-transitory storage media 1010, one or more communications interfaces 1012, one or more positioning devices 1014, one or more input devices 1016, and one or more output devices 1018 communicably coupled via an interconnect 1008. A power source 1020, such as a power supply, battery, or any type of power source may provide power to the computer 1002.

The processor 1004 is representative of any type of processing circuit. For example, the processor 1004 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 1006 is representative of any computer readable medium to store data, code, or other information. The memory 1006 may include volatile memory, such as volatile Random Access Memory (RAM) including a cache area for the temporary storage of data. The memory 1006 may also include non-volatile memory, which can be embedded and/or may be removable. The non-volatile memory can additionally or alternatively include an electrically erasable programmable read-only memory (EEPROM), flash memory or the like. The storage medium 1010 is representative of any type of computer readable medium to store data, code, or other information. Examples of storage media 1010 include solid state drives, hard drives, Redundant Array of Independent Disks (RAID) drives, memory pools, USB storage devices, and the like.

The memory 1006 and storage medium 1010 can store any number and type of computer-executable instructions executed by the processor 1004 to implement the functions of the computer 1002 described herein. For example, the memory 1006 may include such applications as a web browser application and/or a mobile P2P payment system client application. These applications also typically provide a graphical user interface (GUI) on a display that allows the user to communicate with the computer 1002, and, for example a mobile banking system, and/or other devices or systems. In one embodiment, when the user decides to enroll in a mobile banking program, the user downloads or otherwise obtains the mobile banking system client application from a mobile banking system, or from a distinct application server. In other embodiments, the user interacts with a mobile banking system via a web browser application in addition to, or instead of, the mobile P2P payment system client application. Similarly, the memory 1006 and/or storage medium 1010 may be used to store data such as cached data, files for user accounts, user profiles, account balances, transaction histories, files downloaded or received from other devices, and any other data items.

The interconnect 1008 is representative of any type of circuitry to connect the components of the computer 1002. For example, the interconnect 1008 can include or represent, a system bus, a universal serial bus (USB) interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 1004 to the memory 1006, individual electrical connections among the components, and electrical conductive traces on a motherboard common to some or all of the above-described components of the computer 1002. As discussed herein, the interconnect 1008 may operatively couple various components with one another, or in other words, electrically connects those components, either directly or indirectly-by way of intermediate component(s)-with one another.

The one or more input devices 1016 are representative of any type of input device for receiving input, such as a keypad, keyboard, touchscreen, touchpad, microphone, camera, fingerprint sensor, mouse, joystick, other pointer device, button, soft key, and the like. The one or more output devices 1018 are representative of any type of device for outputting information, such as a monitor, speaker, haptic feedback module, printer, and the like.

The computer 1002 may use the communications interface 1012 to communicate with one or more other devices 1024 via a network 1022. The communications interface 1012 allows the computer 1002 to communicate with and conduct transactions with other devices and systems, such as the other devices 1024. The communications interface 1012 may be a wired and/or a wireless interface. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communications interface 1012, which can be or include a radio-frequency transceiver, a Bluetooth device, Wi-Fi device, a Near-Field Communication (NFC) device, and other wireless transceivers. In addition, a positioning device 1014 such as a Global Positioning System (GPS) device may be included for navigation and location-related data exchanges, ingoing and/or outgoing. Wi-Fi networks use radio technologies called IEEE 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). Communications may also and/or alternatively be conducted via wired connections using the communications interface 1012, e.g., using USB, Ethernet, and other physically connected modes of data transfer. The network 1022 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 1002 is configured to use the communications interface 1012 as, for example, a network interface to communicate with one or more other devices on a network such as network 1022. In this regard, the computer 1002 utilizes the wireless communications interface 1012 as an antenna operatively coupled to a transmitter and a receiver (together a “transceiver”) included with the communications interface 1012. The communications interface 1012 is configured to provide signals to and receive signals from the transmitter and receiver, respectively. The signals may include signaling information in accordance with the air interface standard of the applicable cellular system of a wireless telephone network. In this regard, the computer 1002 may be configured to operate with one or more air interface standards, communication protocols, modulation types, and access types. By way of illustration, the computer 1002 may be configured to operate in accordance with any of a number of first, second, third, fourth, fifth-generation communication protocols and/or the like. For example, the as a smartphone, the computer 1002 be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The computer 1002 may also be configured to operate in accordance with non-cellular communication mechanisms, such as via a wireless local area network (WLAN) or other communication/data networks.

The communications interface 1012 may also include a payment network interface. The payment network interface may include software, such as encryption software, and hardware, such as a modem, for communicating information to and/or from one or more devices on a network. For example, the computer 1002 may be configured so that it can be used as a credit or debit card by, for example, wirelessly communicating account numbers or other authentication information to a terminal of the network. Such communication could be performed via transmission over a wireless communication protocol such as the NFC protocol.

The computer 1002 may be under the control of any suitable operating system (not pictured). Example operating systems include, but are not limited to, Linux® operating systems, UNIX®, Windows® operating systems, macOS®, iOS®, Android® and any other type of operating system.

The computer 1002 as illustrated diagrammatically represents at least one example of a possible implementation, where alternatives, additions, and modifications are possible for performing some or all of the described methods, operations, and functions. Although shown separately, in some embodiments, two or more computers 1002, systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A method, comprising:
receiving, by an application executing on a processor, a natural language request to generate source code;
analyzing, by a large language model (LLM) executing on the processor, the natural language request to determine a requested function;
determining, by the LLM based on a source code base, one or more requirements for generating the source code;
generating, by the LLM based on the one or more requirements, the source code; and
storing, by the application, the source code in the source code base.

2. The method of claim 1, further comprising:
determining, by the LLM, a target source code in the source code base;
determining, by the LLM, the one or more requirements comprise integration with the target source code; and
generating, by the LLM, the source code to integrate with the target source code.

3. The method of claim 1, further comprising:
determining, by the LLM, a cloud deployment platform in the source code base;
determining, by the LLM, the one or more requirements comprise integration with the cloud deployment platform;
generating, by the LLM, the source code to integrate with the cloud deployment platform; and
deploying, by the application, the generated source code with the cloud deployment platform.

4. The method of claim 1, wherein the one or more requirements comprise one or more of: (i) a programming language for the source code, (ii) one or more policies, (iii) one or more security requirements, (iv) one or more regulatory requirements, or (v) one or more rules.

5. The method of claim 4, wherein the LLM is trained based at least in part on the source code base and a plurality of requirements for an enterprise system associated with the source code base, wherein the plurality of requirements include the one or more requirements.

6. The method of claim 1, further comprising prior to storing the source code in the source code base:
outputting, by the application, the source code generated by the LLM; and
receiving, by the application, input approving the storage of the source code in the source code base.

7. The method of claim 1, wherein the one or more requirements are not specified as part of the natural language request.

8. A non-transitory computer-readable storage medium, the computer-readable storage medium including instructions that when executed by a processor, cause the processor to:
receive, by an application, a natural language request to generate source code;
analyze, by a large language model (LLM), the natural language request to determine a requested function;
determine, by the LLM based on a source code base, one or more requirements for generating the source code;
generate, by the LLM based on the one or more requirements, the source code; and
store, by the application, the source code in the source code base.

9. The computer-readable storage medium of claim 8, wherein the instructions further cause the processor to:
determine, by the LLM, a target source code in the source code base;
determine, by the LLM, the one or more requirements comprise integration with the target source code; and
generate, by the LLM, the source code to integrate with the target source code.

10. The computer-readable storage medium of claim 8, wherein the instructions further cause the processor to:
determine, by the LLM, a cloud deployment platform in the source code base;
determine, by the LLM, the one or more requirements comprise integration with the cloud deployment platform;
generate, by the LLM, the source code to integrate with the cloud deployment platform; and
deploy, by the application, the generated source code with the cloud deployment platform.

11. The computer-readable storage medium of claim 8, wherein the one or more requirements comprise one or more of: (i) a programming language for the source code, (ii) one or more policies, (iii) one or more security requirements, (iv) one or more regulatory requirements, or (v) one or more rules.

12. The computer-readable storage medium of claim 11, wherein the LLM is trained based at least in part on the source code base and a plurality of requirements for an enterprise system associated with the source code base, wherein the plurality of requirements include the one or more requirements.

13. The computer-readable storage medium of claim 8, wherein the instructions further cause the processor to, prior to storing the source code in the source code base:
output, by the application, the source code generated by the LLM; and
receive, by the application, input approving the storage of the source code in the source code base.

14. The computer-readable storage medium of claim 8, wherein the one or more requirements are not specified as part of the natural language request.

15. An apparatus, comprising:
a processor; and
a memory storing instructions that, when executed by the processor, cause the processor to:
receive, by an application, a natural language request to generate source code;
analyze, by a large language model (LLM), the natural language request to determine a requested function;
determine, by the LLM based on a source code base, one or more requirements for generating the source code;
generate, by the LLM based on the one or more requirements, the source code; and
store, by the application, the source code in the source code base.

16. The apparatus of claim 15, wherein the instructions further cause the processor to:
determine, by the LLM, a target source code in the source code base;
determine, by the LLM, the one or more requirements comprise integration with the target source code; and
generate, by the LLM, the source code to integrate with the target source code.

17. The apparatus of claim 15, wherein the instructions further cause the processor to:
determine, by the LLM, a cloud deployment platform in the source code base;
determine, by the LLM, the one or more requirements comprise integration with the cloud deployment platform;
generate, by the LLM, the source code to integrate with the cloud deployment platform; and
deploy, by the application, the generated source code with the cloud deployment platform.

18. The apparatus of claim 15, wherein the one or more requirements comprise one or more of:
(i) a programming language for the source code, (ii) one or more policies, (iii) one or more security requirements, (iv) one or more regulatory requirements, or (v) one or more rules.

19. The apparatus of claim 18, wherein the LLM is trained based at least in part on the source code base and a plurality of requirements for an enterprise system associated with the source code base, wherein the plurality of requirements include the one or more requirements.

20. The apparatus of claim 15, wherein the instructions further cause the processor to, prior to storing the source code in the source code base:
output, by the application, the source code generated by the LLM; and
receive, by the application, input approving the storage of the source code in the source code base.
